(19) United States
(12) Patent Application Publication
(10) Pub. No.: US 2012/0195392 A1
(43) Pub. Date: Aug. 2, 2012

(54) PREDISTORTION IN SPLIT-MOUNT WIRELESS COMMUNICATION SYSTEMS

(75) Inventors: Igal (Yehuda) Kushnir, Azur (IL); Jonathan Friedmann, Tel Aviv (IL); Ronen Shaked, Netanya (IL); Rafi Ravid, Neve-Monosson (IL)

(73) Assignee: PROVIGENT LTD., Herzlia (IL)

(21) Appl. No.: 13/019,313

(22) Filed: Feb. 2, 2011

(51) Int. Cl. H04L 25/49

(52) U.S. Cl. 375/296

(57) ABSTRACT

A transmitter includes an Outdoor Unit (ODU) including circuitry, and an Indoor Unit (IDU) that is configured to predistort a signal based on a non-linearity model of the circuitry having one or more model parameters, and to forward the predistorted signal to the ODU. The ODU is configured to accept the predistorted signal from the IDU, to amplify and transmit the predistorted signal using the circuitry, to estimate the non linearity model parameters, and to send the estimated model parameters to the IDU so as to cause the IDU to apply the model parameters in predistoring the signal.

### FIELD OF THE INVENTION

The present invention relates generally to communication systems, and particularly to methods and devices for compensation for distortion in radio transmitters.

### BACKGROUND OF THE INVENTION

Pre-distortion of nonlinear distortion in High-Power Amplifiers (HPAs) is known in the art. Some pre-distortion schemes are applied in transmitters whose functions are split between an Indoor Unit (IDU) and an Outdoor Unit (ODU). For example, U.S. Patent Application Publication 2005/0124307, whose disclosure is incorporated herein by reference, describes a system for millimeter wave communications that includes an IDU and a compact ODU connected by a cable. The ODU has a modem circuit, an intermediate frequency circuit, a millimeter wave transceiver circuit and digital interface between the IDU and the ODU. Any detected power and phase are sent to a processor, which computes pre-distortion coefficients to be used in the modem for correcting HPA nonlinearity.

As another example, European Patent Application Publication EP 1592127, whose disclosure is incorporated herein by reference, describes an analog pre-distortion linearizer that includes phase and amplitude pre-distorters. Both pre-distorters are controlled so as to introduce phase and amplitude pre-distortions at higher power levels of the input signal with opposite trends with respect to the distortion ones introduced by the power amplifier. The linearizer may be far from the power amplifier. In this case the linearizer is housed in an IDU connected to an ODU, including the radio frequency conversion stage and the transmission power amplifier, by means of physical connection at IF such as coaxial cable. As yet another example, U.S. Patent Application

Publication 2009/0285270, whose disclosure is incorporated herein by reference, describes an RF transceiver, comprising a first module and a second module physically isolated from the first module. The first module comprises a modulator and a digital-to-analog converter. The second module is coupled to the first module through a connection cable and comprises an amplifier. Analog signals are sent to the amplifier through the cable, and the modulator performs signal pre-distortion to compensate for signal distortions caused by the amplification of the amplifier. A processor, which is located in the first module, controls the modulator to perform signal pre-distortion that is based on a portion of the amplifier output signal, which is sampled by a coupler and fed back to the first module through a signal receiving path.

### SUMMARY OF THE INVENTION

An embodiment of the present invention that is described herein provides a transmitter, including:

an Outdoor Unit (ODU) including circuitry; and

an Indoor Unit (IDU), which is configured to predistort a signal based on a non-linearity model of the circuitry having one or more model parameters, and to forward the predistorted signal to the ODU,

wherein the ODU is configured to accept the predistorted signal from the IDU, to amplify and transmit the predistorted signal using the circuitry, to estimate the non linearity model parameters, and to send the estimated model parameters to the IDU so as to cause the IDU to apply the model parameters in predistoring the signal.

In some embodiments, the signal has a bandwidth, and the ODU is configured to send the estimated model parameters to the IDU at a rate that is smaller than the bandwidth. In an embodiment, the circuitry includes at least a Power Amplifier (PA) of the ODU. In a disclosed embodiment, the non-linearity model is independent of an output power of the ODU.

In some embodiments, the ODU is configured to estimate the model parameters by sampling the predistorted signal at an input and at an output of the circuitry, and assessing the model parameters based on both sampled signals. In an example embodiment, the ODU is configured to sample the predistorted signal at the input of the circuitry at baseband. In another embodiment, the ODU is configured to sample the predistorted signal at the input of the circuitry at Intermediate Frequency (IF). In yet another embodiment, the circuitry includes at least a Power Amplifier (PA) of the ODU, and the ODU is configured to sample the predistorted signal at an output of the PA.

In some embodiments, the model parameters approximate the non-linearity model in a vicinity of a currently-used output power. In an embodiment, the model parameters approximate an AM/AM transfer characteristic of the circuitry. In another embodiment, the model parameters approximate an AM/PM transfer characteristic of the circuitry. In yet another embodiment, the model parameters are indicative of one or more inter-modulation products generated by the circuitry. In still another embodiment, the model parameters include indices that point to respective parameter values that are stored in the IDU. In an embodiment, the model parameters are indicative of a memory effect caused by the circuitry.

In a disclosed embodiment, the ODU is configured to send the estimated model parameters to the IDU in accordance with a predetermined updating policy. The updating policy may specify at least one updating criterion selected from a group of criteria consisting of updating the model parameters upon transmitter deployment, upon transmitter wakeup, once per a selected time period, upon an operating temperature change, upon an output power change, and upon a predetermined amount of change in the model parameters.

There is additionally provided, in accordance with an embodiment of the present invention, a method, including:

in an Indoor Unit (IDU), predistorting a signal based on a non-linearity model of circuitry that is located in an Outdoor Unit (ODU), the non-linearity model having one or more model parameters, and forwarding the predistorted signal to the ODU; and

in the ODU, accepting the predistorted signal from the IDU, amplifying and transmitting the predistorted signal to a remote receiver using the circuitry, estimating the model parameters by processing the predistorted signal, and sending the estimated model parameters to the IDU so as to cause the IDU to apply the model parameters in predistoring the signal.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a split-mount radio transmitter, in accordance with an embodiment of the present invention;

FIG. 2 is a flow chart that schematically illustrates a method for pre-distortion in a split-mount radio transmitter, in accordance with an embodiment of the present invention; and

FIGS. 3 and 4 are block diagrams that schematically illustrate radio transmitter ODUs, in accordance with embodiments of the present invention.

### DETAILED DESCRIPTION OF EMBODIMENTS

### Overview

Embodiments of the present invention that are described herein provide improved methods and systems for predistortion in split-mount transmitters. A split-mount transmitter typically comprises an Indoor Unit (IDU) that is connected to an Outdoor Unit (ODU) using a cable connection. The ODU comprises circuitry, such as an up-converter and a Power Amplifier (PA), which may introduce non-linear distortion into the transmitted signal. The disclosed techniques correct the non-linear distortion caused by the ODU circuitry using a Pre-Distortion (PD) unit that is located in the IDU.

In some embodiments, the non-linear distortion of the ODU circuitry is modeled using a certain non-linearity model having one or more model parameters. The ODU comprises a processor, which analyzes the signal that is processed by the ODU and estimates the model parameters. The processor then sends the estimated model parameters to the IDU over the cable connection. The PD unit in the IDU accepts the estimated model parameters from the ODU, and predistorts the signal based on these parameters.

Several example transmitter configurations are described below. In some configurations, the ODU down-converts the signal from both the input and the output of the circuitry in question in order to estimate the non-linearity model parameters. In other configurations, the signal at the input of the circuitry is inherently available in baseband form, and thus only the signal at the output of the circuitry is down-converted. The disclosed techniques can be used to predistort any suitable circuitry in the ODU, such as the PA, a pre-amplifier that precedes the PA, an up-converter, any combination of these elements, or even the entire ODU.

Since the ODU sends to the IDU only the non-linearity model parameters and not the actual transmitted signal or parts thereof, the throughput of the feedback from the ODU to the IDU is low. Typically, the feedback throughput is considerably lower than the bandwidth of the transmitted signal. In some embodiments, the model parameters do not depend on the transmitter output power but rather on slowly-varying characteristics such as temperature and aging, so as to maintain small feedback throughput.

The low feedback throughput achieved by transferring only model parameters eliminates the need for a broadband (e.g., RF) ODU-to-IDU link that would have been needed had that processing been performed in the IDU. As a result, the cost and complexity of the transmitter are reduced. Additionally, the disclosed techniques are insensitive to group delay variations over the IDU-ODU link, and therefore eliminate the need for complex circuitry which would typically be needed for compensating for such group delay. Moreover, the techniques described herein may replace lengthy, costly and less accurate factory or on-site processes for calibrating the PD function.

### System Description

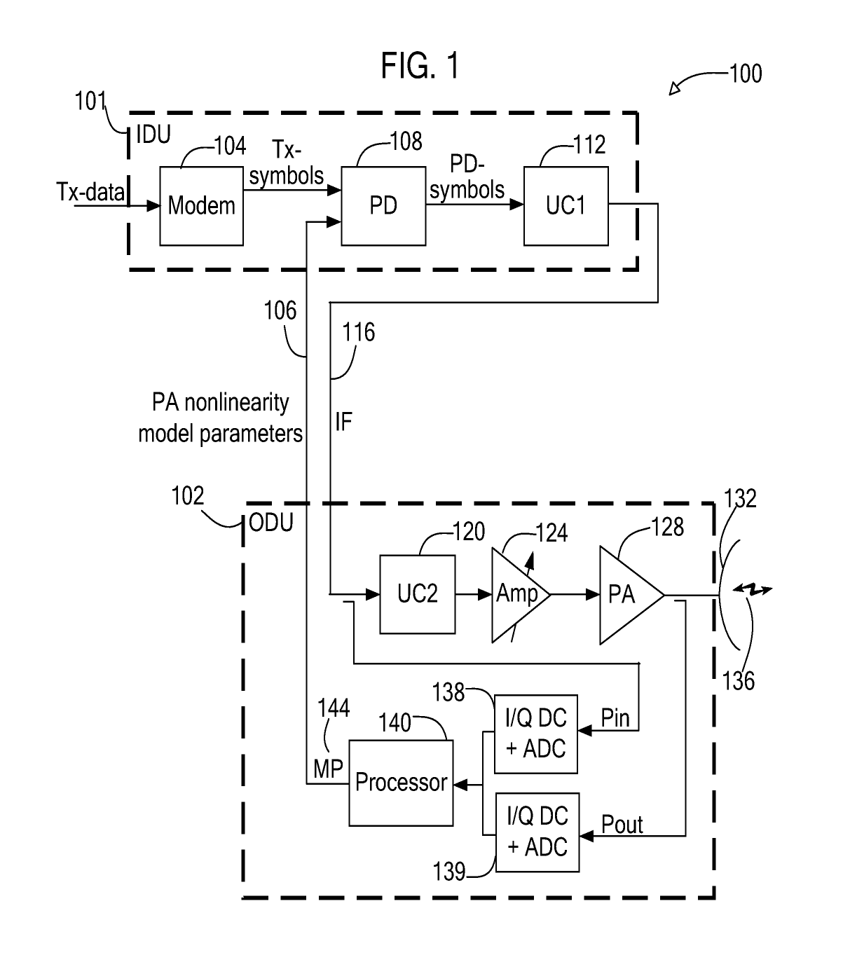

FIG. 1 is a block diagram that schematically depicts a split-mount radio transmitter 100, which comprises an IDU 101 and an ODU 102, wherein the transmitter PA is pre-distorted in accordance with an embodiment of the present invention. A modem 104 in IDU 101 generates baseband symbols, denoted Tx-symbols, from transmit data, denoted Tx-data, which is accepted at the IDU input. The Tx-symbols typically constitute an I/Q quadrature signal wherein each quadrature component comprises a time sequence of digital samples. A Pre-Distortion (PD) module 108 predistorts the baseband signal by applying a certain PD function to the baseband symbols or samples. PD module 108 typically sets the PD function to comprise a nonlinearity which attempts to approximate the inverse of the transmitter PA nonlinearity. The PD function is updated through a feedback link 106 as will be explained hereafter. An up-converter 112, denoted UC1, converts the pre-distorted symbols to IF signal. A forwarding link 116, for example a connection cable, carries this IF signal from IDU 101 to ODU 102.

Within ODU 102, an up-converter 120, denoted UC2, converts the IF signal arriving through forwarding link 116 to RF modulated carrier. Amplification stages 124 amplify the RF carrier. A PA 128 further amplifies the RF carrier and provides it to an antenna 132 for transmission over an RF channel 136. Sampled signals at ODU 102 input and PA 128 output ports are denoted in FIG. 1 Pin and Pout respectively, wherein Pin represents the transmitted signal prior to undergoing nonlinear distortion at the ODU. I/Q Down-Converter (DC)+Analog to Digital Converters (ADCs) 138 and 139 convert Pin and Pout respectively to digital form at baseband. ODU 102 further comprises a processor 140, which accepts the converted Pin and Pout Processor 140 then analyzes Pin and Pout, so as to evaluate one or more nonlinearity model parameters of PA 128. Processor 140 then transfers the evaluated nonlinearity model parameters via a port MP 144 and feedback link 106 to PD module 108 at IDU 101. PD module 108 adapts the PD function based on the nonlinearity model parameters.

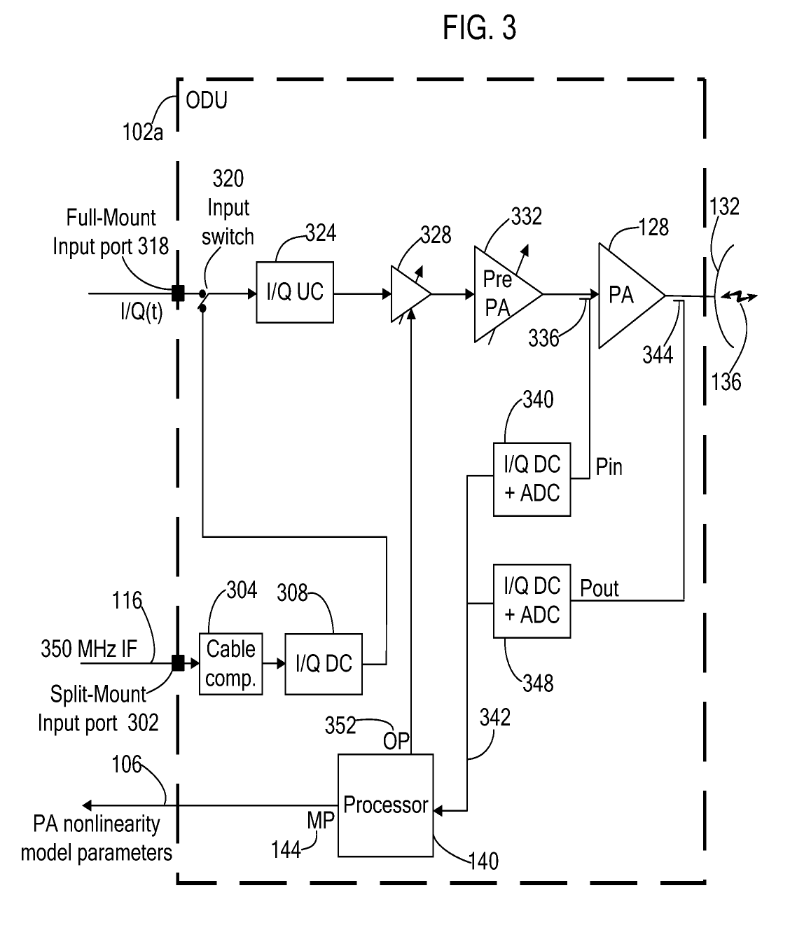

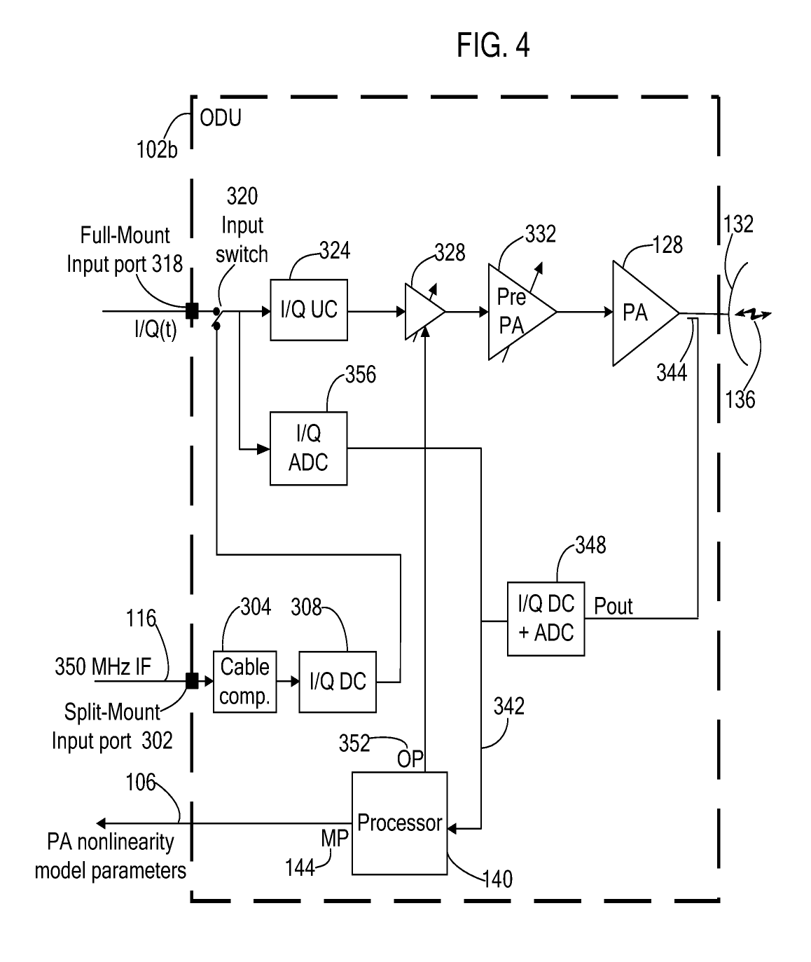

The configuration of transmitter 100 shown in FIG. 1 is an example configuration, which is chosen purely for the sake of conceptual clarity. In alternative embodiments, any other suitable transmitter configuration can also be used. In the example of FIG. 1, PD unit 108 corrects the distortion that is caused by up-converter 120, amplifier 124 and PA 128. In alternative embodiments, the PD unit may correct the distortion that is caused by any other suitable circuitry that is part of the ODU signal path, which may comprise one or more components. An example embodiment in which only the ODU PA is predistorted is shown in FIG. 3 below. Transmitter elements that are not mandatory for understanding the disclosed techniques were omitted from the figure for the sake of clarity. Example implementations of ODU 102 are shown in FIGS. 3 and 4 below.

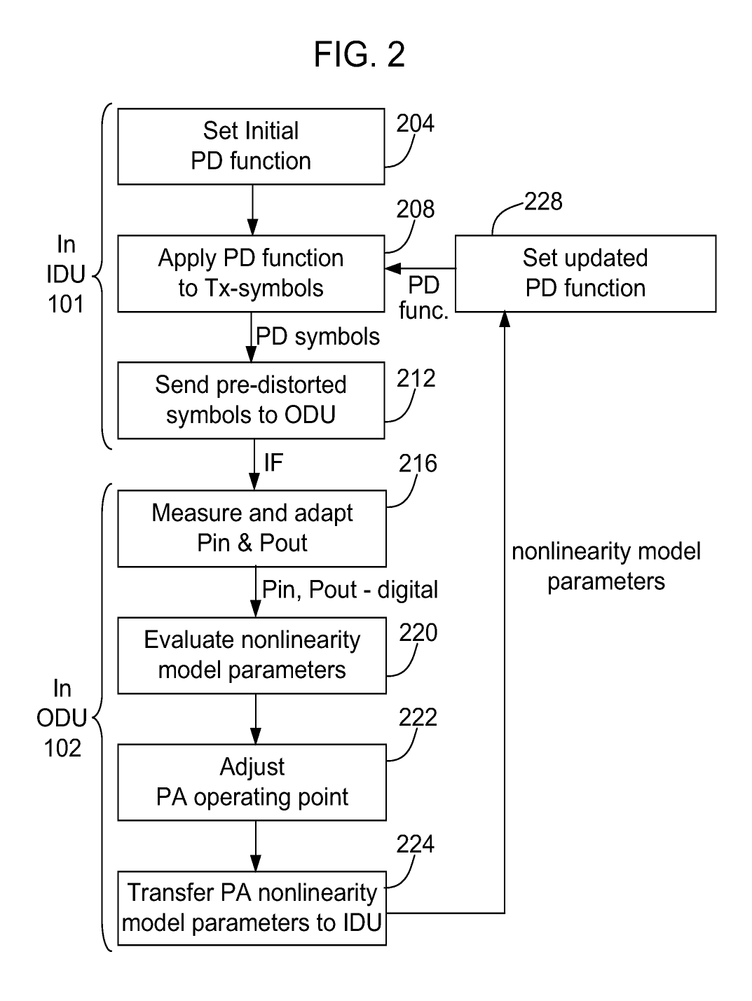

FIG. 2 is a flow chart that schematically illustrates a method for pre-distorting PA 128 of split-mount radio transmitter 100, in accordance with an embodiment of the present invention. Although the description below refers to predistortion that is applied to symbols, the method can similarly be used with predistortion that is applied to samples. Although the description that follows refers mainly to PA nonlinearity, the method can be used to correct non-linear distortion caused by any suitable ODU circuitry.

The method begins with initialization step 204, wherein PD module 108 within IDU 101 sets a PD function to an initial form. The initial PD function form may comprise, for example, null, i.e. a linear transfer, or a function that is based on some initial information that is known about the type of PA 128.

PD module 108 applies the PD function to the transmitted baseband symbols or samples in a pre-distortion step 208. Forwarding link 116 provides the resulting pre-distorted symbols or samples, carried on IF, to ODU 102 in a cable transmission step 212. In a measurement step 216, which is the first to take place in ODU 102, I/Q DC+ADCs 138 and 139 convert samples of ODU 102 input and PA 128 output signals, denoted Pin and Pout respectively, to a digital form. In a parameter evaluation step 220 processor 140 analyzes the converted Pin and Pout so as to evaluate one or more of the parameters that characterize PA 128 nonlinearity model.

When implementing step 220, processor 140 may evaluate any suitable nonlinearity model of PA 128. The nonlinearity model typically comprises one or more parameters, which are indicative of the distortion that is caused by PA 128. In an example embodiment, processor 140 evaluates a nonlinearity model that is defined in terms of momentary power, denoted “envelope”.

More particularly, the nonlinearity model is defined by Pout envelope as a function over time of Pin envelope, which is often denoted AM/AM transfer characteristic. Processor 140 optionally evaluates also the PA phase transfer characteristic as a function over time of its input envelope, often denoted AM/PM. For evaluating the above functions processor 140 typically compensates for a small constant group delay that may exist between both analyzed signals. In an example embodiment processor 140 typically produces a set of model parameters that relate to the PA nonlinearity.

In another example embodiment, the model parameters produced by processor 140 comprise indices that point to respective parameter values that are stored in the IDU. For example, the ODU and IDU may use a predefined set of possible PA transfer functions (e.g., possible AM/AM and/or AM/PM characteristics). In these embodiments, processor 140 sends to the IDU only the index of the transfer function that best matches the actual PA nonlinearity, as measured by the ODU. This technique further reduce feedback throughput.

In an alternative embodiment of step 220, processor 140 computes the power spectrum of Pout and optionally also the power spectrum of Pin. The Pout spectrum typically contains Inter-Modulation (IM) spectral products, e.g., 3^{rd} and 5^{th} order products, which are created due to the nonlinear transfer of ODU 102. Those components fall in specific frequencies within and out of the bandwidth of the transmitted signal. The IM products may be isolated and measured, in some embodiments, by some adaptation circuitry not shown in FIG. 1, or by processor 140. Processor 140 analyzes the computed power spectra, identifies the IM products thereof and evaluates the PA nonlinearity accordingly. Processor 140 then produces a set of model parameters that relate to the evaluated IM. The model parameters in this embodiment may comprise, for example, estimated magnitudes of the 3^{rd}, 5^{th} and/or 7^{th} order IM products.

In another example embodiment processor 140 may evaluate the characteristics of PA 108 out of the IM, and produce a set of parameters that relate to these characteristics. In another embodiment, the distortion of the PA (or other ODU circuitry) comprises memory effects, and the nonlinearity model parameters estimated by processor 140 indicate this memory effect and enable PD unit 108 to compensate for it. Thus, the disclosed techniques are suitable for predistorting both memoryless non-linearity and nonlinearity having memory effects. In some embodiments, the model parameters estimate the non-linearity model in the vicinity of the currently-used output power. Further alternatively, processor 140 may evaluate any other suitable type of nonlinearity model having one or more parameters.

In an optional adjustment step 222, processor 140 adjusts the operating point of PA 128 in accordance with the analysis of Pin and Pout and the evaluated transfer curves of the PA in order to maximize the transmitted power while retaining a minimal allowed nonlinearity distortion. In a parameter transmission step 224, processor 140 transfers the one or more evaluated PA 128 nonlinearity model parameters back to IDU 101 through feedback link 106. In a pre-distortion adjustment step 228, PD module 108 in IDU 101 sets an updated PD function to be applied to the transmitted symbols according to the recently transferred nonlinearity model parameters.

In some embodiments, processor 140 initiates step 224 according to an updating policy that may be optionally selected by the transmitter operator. Example updating policies may comprise, for example, updating the PD function upon system deployment or wakeup, once per a selected time period, e.g. a few seconds or a few minutes, upon a change in ODU or IDU operating temperature, upon a change in output power, or upon a predetermined amount of change in the nonlinearity model parameters. Further alternatively, the PD function may be updated according to any other suitable policy or criterion. Different update policies provide different trade-offs between pre-distortion accuracy, computational power in processor 140 and data throughput over feedback link 106.

FIG. 3 is a block diagram that schematically illustrates an ODU configuration denoted 102a of transmitter 100, in accordance with an embodiment of the present invention. In the present example, forwarding link 116 comprises an IF connection cable, which leads a 350 MHz IF modulated carrier from IDU 101 into ODU 102 through a split-mount input port 302. An I/Q DC 308 down-converts the IF signal to quadrature baseband symbols. The purpose of the down-conversion is to adapt the incoming IF signal to a subsequent up-conversion circuitry within ODU 102a, which is designed to accept baseband symbols for transmission.

A switch 320 selects between two optional baseband quadrature signals: the signal arriving from I/Q DC 308, and a signal I/Q(t) that is optionally provided through a full-mount input port 318 when the baseband circuitry of transmitter 100 is packaged together with ODU 102 circuitry. This latter configuration is sometimes referred to as a full-mount configuration. An I/Q UC 324 up-converts the quadrature baseband signal at the output of switch 320 to RF modulated carrier. A variable-gain amplifier 324 and a pre-amplifier 328 adapt the RF signal level to PA 128, which amplifies the signal and transfers it to antenna 132. In an alternative embodiment of the present invention that does not support full-mount configuration, the incoming IF signal at port 302 may be directly and non-quadratically up-converted by f_{LO} and then fed to amplifier 328 input.

The elements of FIG. 3 that have been described so far relate to the main transmitted signal path in ODU 102a. The remaining elements in the drawing relate to measuring PA 128 input and output signals, adapting the measured signals to processor 140 and evaluating PA 128 nonlinearity model parameters thereof by the processor. In this specific enablement, the nonlinearity of the ODU stages that precede PA 128 is assumed negligible relative to the nonlinearity of the PA itself. Starting with PA 128 input signal, a directional coupler 336 samples it and provides the resulting measured signal, denoted Pin, to an I/Q DC+ADC 340. The I/Q down-converter converts Pin signal to quadrature baseband symbol sequence, while the ADC further converts the sequence to digital form and transfers it to processor 140 through an interface 342. Interface 342 is implemented in a typical example embodiment as a parallel processor bus.

Similarly to the above Pin related element chain, a chain that comprises a coupler 336 and a I/Q DC+ADC 348 is used for measuring the PA 128 output signal, whose sample is denoted Pout, and adapting it to processor 140.

In an example embodiment wherein processor 140 evaluates the AM/AM transfer curve of PA 128, the processor reconstructs the envelope variations of Pin and Pout by computing the phasor sum of the quadrature components of each of them over time. For evaluating the AM/PM transfer curve of PA 128 processor 140 computes the phase variations of Pin and Pout according to the Arcing of the quadrature components of each of them. In some embodiments, processor 140 further compensates, on the time axis, for a known constant delay difference that exists between the above two measurement and adaptation channels.

In alternative embodiments of the present invention processor 140 computes the spectrum of Pout, and optionally also the spectrum of Pin, and then computes the IM spectral products of Pout and evaluates the nonlinearity model parameters of PA 128 accordingly. In an example embodiment wherein PA 128 nonlinearity model evaluation is based either on PA 128 AM/AM transfer curve or on the IM products of Pout, the quadrature parts of down-converters 340 and 348 may be eliminated.

Processor 140 finally transfers the one or more evaluated nonlinearity model parameters of PA 128 to IDU 101 through port MP 144 and feedback link 106. In a typical embodiment of the present invention, feedback link 106 comprises a connection cable. In alternative embodiments link 106 may be implemented either as a wireless link, as an optical link or as part of a data link that connects ODU 102a and IDU 101 and is used for some other monitoring and control purposes as well.

In some example embodiments, processor 140 optionally controls the gain of variable amplifier 328 through a port 352, denoted OP, for achieving a desired operating point of PA 128 according to the analysis of Pin and Pout and the evaluated transfer characteristics of PA 128. In alternative embodiments of the present invention, wherein the modulating signal is analog, the quadrature parts of mixers 308 and 324 may be eliminated.

FIG. 4 illustrates a block diagram of an ODU 102b, in accordance with an alternative embodiment of the present invention. Compared to the block diagram of FIG. 3, the nonlinearity model is determined by the entire ODU rather than by PA 128 only. This is achieved by substituting I/Q DC+ADC 340 with an I/Q ADC 356, which converts the quadrature baseband symbols at the ODU input to digital form for analysis in processor 140.

The analog components in the IDU and ODUs described herein may be implemented using discrete components and/or using one or more RF Integrated Circuits (RFICs) or Miniature Monolithic Integrated Circuits (MMICs). Digital elements, and in particular processor 140, may be implemented in hardware, such as using one or more Field-Programmable Gate Arrays (FPGAs) or Application-Specific Integrated Circuits (ASICs). Alternatively, processor 140 may be implemented in software, or using a combination of hardware and software elements. Processor 140 and its peripheral components (e.g., I/Q DC+ADC 138 and 139 in FIG. 1, I/Q DC+ADC 340 and 348 in FIG. 3 and I/Q DC+ADC 348 and I/Q ADC 356 in FIG. 4 are regarded herein as processing circuitry, which evaluates the nonlinearity model parameters based on the ODU input and output, or the PA input and output in case of FIG. 2.

Although the embodiments described herein mainly address terrestrial microwave links, the methods and systems described herein can also be used in other applications, such as in satellite or cable communication.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A transmitter, comprising:
an Outdoor Unit (ODU) comprising circuitry; and
an Indoor Unit (IDU), which is configured to predistort a signal based on a non-linearity model of the circuitry having one or more model parameters, and to forward the predistorted signal to the ODU,
wherein the ODU is configured to accept the predistorted signal from the IDU, to amplify and transmit the predistorted signal using the circuitry, to estimate the non linearity model parameters, and to send the estimated model parameters to the IDU so as to cause the IDU to apply the model parameters in predistoring the signal.

2. The transmitter according to claim 1, wherein the signal has a bandwidth, and wherein the ODU is configured to send the estimated model parameters to the IDU at a rate that is smaller than the bandwidth.

3. The transmitter according to claim 1, wherein the circuitry comprises at least a Power Amplifier (PA) of the ODU.

4. The transmitter according to claim 1, wherein the non-linearity model is independent of an output power of the ODU.

5. The transmitter according to claim 1, wherein the ODU is configured to estimate the model parameters by sampling the predistorted signal at an input and at an output of the circuitry, and assessing the model parameters based on both sampled signals.

6. The transmitter according to claim 5, wherein the ODU is configured to sample the predistorted signal at the input of the circuitry at baseband.

7. The transmitter according to claim 5, wherein the ODU is configured to sample the predistorted signal at the input of the circuitry at Intermediate Frequency (IF).

8. The transmitter according to claim 5, wherein the circuitry comprises at least a Power Amplifier (PA) of the ODU, and wherein the ODU is configured to sample the predistorted signal at an output of the PA.

9. The transmitter according to claim 1, wherein the model parameters approximate the non-linearity model in a vicinity of a currently-used output power.

10. The transmitter according to claim 1, wherein the model parameters approximate an AM/AM transfer characteristic of the circuitry.

11. The transmitter according to claim 1, wherein the model parameters approximate an AM/PM transfer characteristic of the circuitry.

12. The transmitter according to claim 1, wherein the model parameters are indicative of one or more inter-modulation products generated by the circuitry.

13. The transmitter according to claim 1, wherein the model parameters comprise indices that point to respective parameter values that are stored in the IDU.

14. The transmitter according to claim 1, wherein the model parameters are indicative of a memory effect caused by the circuitry.

15. The transmitter according to claim 1, wherein the ODU is configured to send the estimated model parameters to the IDU in accordance with a predetermined updating policy.

16. The transmitter according to claim 15, wherein the updating policy specifies at least one updating criterion selected from a group of criteria consisting of updating the model parameters upon transmitter deployment, upon transmitter wakeup, once per a selected time period, upon an operating temperature change, upon an output power change, and upon a predetermined amount of change in the model parameters.

17. A method, comprising:
in an Indoor Unit (IDU), predistorting a signal based on a non-linearity model of circuitry that is located in an Outdoor Unit (ODU), the non-linearity model having one or more model parameters, and forwarding the predistorted signal to the ODU; and
in the ODU, accepting the predistorted signal from the IDU, amplifying and transmitting the predistorted signal to a remote receiver using the circuitry, estimating the model parameters by processing the predistorted signal, and sending the estimated model parameters to the IDU so as to cause the IDU to apply the model parameters in predistoring the signal.

18. The method according to claim 17, wherein the signal has a bandwidth, and wherein sending the estimated model parameters comprises transferring the estimated model parameters from the ODU to the IDU at a rate that is smaller than the bandwidth.

19. The method according to claim 17, wherein the circuitry comprises at least a Power Amplifier (PA) of the ODU.

20. The method according to claim 17, wherein the non-linearity model is independent of an output power of the ODU.

21. The method according to claim 17, wherein estimating the model parameters comprises sampling the predistorted signal at an input and at an output of the circuitry, and assessing the model parameters based on both sampled signals.

22. The method according to claim 21, wherein sampling the predistorted signal comprises sampling the predistorted signal at the input of the circuitry at baseband.

23. The method according to claim 21, wherein sampling the predistorted signal comprises sampling the predistorted signal at the input of the circuitry at Intermediate Frequency (IF).

24. The method according to claim 21, wherein the circuitry comprises at least a Power Amplifier (PA) of the ODU, and wherein sampling the predistorted signal comprises sampling the predistorted signal at an output of the PA.

25. The method according to claim 17, wherein the model parameters approximate the non-linearity model in a vicinity of a currently-used output power.

26. The method according to claim 17, wherein the model parameters approximate an AM/AM transfer characteristic of the circuitry.

27. The method according to claim 17, wherein the model parameters approximate an AM/PM transfer characteristic of the circuitry.

28. The method according to claim 17, wherein the model parameters are indicative of one or more inter-modulation products generated by the circuitry.

29. The method according to claim 17, wherein the model parameters comprise indices that point to respective parameter values that are stored in the IDU.

30. The method according to claim 17, wherein the model parameters are indicative of a memory effect caused by the circuitry.

31. The method according to claim 17, wherein sending the estimated model parameters comprises transferring the estimated model parameters from the ODU to the IDU in accordance with a predetermined updating policy.

32. The method according to claim 31, wherein the updating policy specifies at least one updating criterion selected from a group of criteria consisting of updating the model parameters upon deployment, upon wakeup, once per a selected time period, upon an operating temperature change, upon an output power change, and upon a predetermined amount of change in the model parameters.
